(19) United States
(12) Patent Application Publication
(10) Pub. No.: US 2006/0036597 A1
(43) Pub. Date: Feb. 16, 2006

(54) Information processing apparatus and method, recording medium, and program

(75) Inventor: Yoshiyuki Kobayashi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/193,485

(22) Filed: Aug. 1, 2005

(30) Foreign Application Priority Data
Aug. 4, 2004 (JP) 2004-227540

(51) Int. Cl. G06F 17/30

(52) U.S. Cl. 707/5

(57) ABSTRACT

The present invention includes an information processing apparatus performing a process for a plurality of object contents that each has a characteristic represented by a plurality of different characteristic amounts and becomes an object of search or recommendation. The apparatus includes weight calculation means for calculating, from preference degrees of a user with regard to a plurality of designated contents designated from among the object contents and values of the characteristic amounts of the predetermined number of designated contents, weights for the characteristic amounts of the contents to the user. The apparatus also includes similarity calculation means for calculating a similarity between arbitrary ones of the object contents using the weights for the characteristic amounts to the user calculated by the weight calculation means.

### CROSS REFERENCES TO RELATED APPLICATIONS

The present invention contains subject matter related to Japanese Patent Application JP 2004-227540 filed in the Japanese Patent Office on Aug. 4, 2004, entire contents of which being incorporated herein by reference.

### BACKGROUND OF THE INVENTION

This invention relates to an information processing apparatus and method, a recording medium, and a program, and more particularly to an information processing apparatus and method, a recording medium, and a program by which the similarity between a designated content and object contents, which become an object of search or recommendation, can be calculated.

Variable contents are currently available including broadcasting programs of television broadcasting and radio broadcasting, movies, images of photographs and so forth, tunes (sound), and various kinds of information such as information of cooking, travel, shopping, and so forth presented on a side of the Internet. A user frequently searches for a content, which conforms to the preference of the user itself, from among a large number of such contents.

As a method of searching for a content conforming to the preference of a user, a plurality of characteristic amounts representative of characteristics of contents are used to calculate the similarity of the characteristic amounts between a designated content designated by the user and search object contents, which become an object of search. Then, that one of the search object contents, which exhibits a comparatively high similarity to the designated content, is determined as a content conforming to the preference of the user.

For example, Japanese Patent Laid-open No. Hei 10-171826 (hereinafter referred to as Patent Document 1) discloses a similar object searching apparatus. According to the similar object searching apparatus of Patent Document 1, a search key object (content), which is to be used as a search key, is inputted. Then, from the characteristic amounts of the search key object and the characteristic amounts of objects stored in a characteristic amount storing and managing apparatus, the similarity between the characteristic amounts is calculated. Then, those objects whose similarity is higher than a predetermined value are ordered in the descending order of the similarities and outputted in this order.

In related art, when the similarity of characteristic amounts between a designated content and search object contents in content search is calculated, the calculation is performed assuming that the degrees of significance (weights) for the characteristic amounts of the contents are all equal to each other.

### SUMMARY OF THE INVENTION

However, as a user has a degree of preference with regard to a content, the user similarly has a degree of preference with regard to a characteristic amount of a content. For example, where a tune is taken as a content, if the characteristic amounts of the content are, for example, the tempo, mood, and quantity of sounds, then a certain user may not consider the tempo or the quantity of sounds significant, but consider the mood significant in search for a content.

However, in search for a content in related art, the similarity between a designated content and search object contents is not calculated taking it into consideration to which one or ones of the characteristic amounts of contents the user is sensitive (which one of the characteristics is considered significant by the user), or in other words, taking an individual difference in feeling to a user with regard to the characteristic amounts into consideration. Accordingly, it is considered that, in content search, a content conforming most (optimum) to the preference of the user is not searched out (presented).

It is desirable to provide an information processing apparatus and method, a recording medium, and a program by which the similarity between a designated content and an object content, which becomes an object of search or recommendation, can be calculated taking an individual difference in feeling to a user with regard to characteristic amounts into consideration.

According to an embodiment of the present invention, there is provided an information processing apparatus performing a process for a plurality of object contents that each has a characteristic represented by a plurality of different characteristic amounts and becomes an object of search or recommendation. The apparatus includes weight calculation means for calculating, from preference degrees of a user with regard to a plurality of designated contents designated from among the object contents and values of the characteristic amounts of the predetermined number of designated contents, weights for the characteristic amounts of the contents to the user. The apparatus also includes similarity calculation means for calculating a similarity between arbitrary ones of the object contents using the weights for the characteristic amounts to the user calculated by the weight calculation means.

According to another embodiment of the present invention, there is provided an information processing method of performing a process for a plurality of object contents that each has a characteristic represented by a plurality of different characteristic amounts and becomes an object of search or recommendation. The method includes the steps of calculating, from preference degrees of a user with regard to a plurality of designated contents designated from among the object contents and values of the characteristic amounts of the predetermined number of designated contents, weights for the characteristic amounts of the contents to the user, and calculating a similarity between arbitrary ones of the object contents using the weights for the characteristic amounts to the user calculated by the process at the weight calculation step.

According to a further embodiment of the present invention, there is provided a recording medium on which a computer-readable program for performing a process for a plurality of object contents that each has a characteristic represented by a plurality of different characteristic amounts and becomes an object of search or recommendation. The program includes the steps of calculating, from preference degrees of a user with regard to a plurality of designated contents designated from among the object contents and values of the characteristic amounts of the predetermined number of designated contents, weights for the characteristic amounts of the contents to the user, and calculating a similarity between arbitrary ones of the object contents using the weights for the characteristic amounts to the user calculated by the process at the weight calculation step.

According to a still further embodiment of the present invention, there is provided a program for causing a computer to execute a process for a plurality of object contents that each has a characteristic represented by a plurality of different characteristic amounts and becomes an object of search or recommendation. The program includes the steps of calculating, from preference degrees of a user with regard to a plurality of designated contents designated from among the object contents and values of the characteristic amounts of the predetermined number of designated contents, weights for the characteristic amounts of the contents to the user, and calculating a similarity between arbitrary ones of the object contents using the weights for the characteristic amounts to the user calculated by the process at the weight calculation step.

According to an embodiment of the present invention, there is provided an information processing apparatus performing a process for a plurality of object contents that each has a characteristic represented by a plurality of different characteristic amounts and becomes an object of search or recommendation. The apparatus includes a weight calculation section for calculating, from preference degrees of a user with regard to a plurality of designated contents designated from among the object contents and values of the characteristic amounts of the predetermined number of designated contents, weights for the characteristic amounts of the contents to the user. The apparatus also includes a similarity calculation section for calculating a similarity between arbitrary ones of the object contents using the weights for the characteristic amounts to the user calculated by said weight calculation section.

In the information processing apparatus and method, recording medium, and program, from preference degrees to a user with regard to a plurality of designated contents designated from among object contents and the values of characteristic amounts of the predetermined number of designated contents, weights for the characteristic amounts of the contents to the user are calculated. Then, a similarity between arbitrary ones of the object contents is calculated using the calculated weights for the characteristics to the user.

With the information processing apparatus and method, recording medium, and program, the similarity between a designated content and an object content, which becomes an object of search or recommendation, can be calculated taking an individual difference in feeling to a user with regard to the characteristic amounts into consideration.

### BRIEF DESCRIPTION OF THE DRAWINGS

These and other objects of the invention will be seen by reference to the description, taken in connection with the accompanying drawings, in which:

FIG. 1 is a functional block diagram showing a configuration of a content presentation apparatus according to an embodiment of the present invention;

FIG. 2 is a view illustrating an example of data of characteristic amounts of a designated content;

FIGS. 3 to 10 are views illustrating a process of determining weighting coefficients of characteristic amounts;

FIG. 11 is a diagrammatic view illustrating an example of determination of a weighting coefficient for the tempo to a certain user;

FIG. 12 is a similar view but illustrating an example of determination of a weighting coefficient for the mood to a certain user;

FIG. 13 is a similar view but illustrating an example of determination of a weighting coefficient for the quantity of sounds to a certain user;

FIG. 14 is a view illustrating an example of a calculation result by a similarity calculation section;

FIG. 15 is a view illustrating a calculation result by a score calculation section or a synthesis section;

FIG. 16 is a flow chart illustrating a content presentation process of the content presentation apparatus;

FIG. 17 is a flow chart illustrating a score calculation process of the content presentation apparatus; and

FIG. 18 is a block diagram showing an example of a configuration of a computer according to an embodiment of the present invention.

### DETAILED DESCRIPTION OF THE PREFERRED EMBODIMENT

Before a preferred embodiment of the present invention is described in detail, a corresponding relationship between several features recited in the accompanying claims and particular elements of the preferred embodiment described below is described. The description, however, is merely for the confirmation that the particular elements supporting the invention as recited in the claims are disclosed in the description of the embodiment of the present invention. Accordingly, even if some particular element recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

Further, the following description does not signify that the prevent invention corresponding to particular elements described in the embodiment of the present invention is all described in the claims. In other words, the following description does not deny the presence of an invention that corresponds to a particular element described in the description of the embodiment of the present invention but is not recited in the claims, that is, the description does not deny the presence of an invention that may be filed for patent in a divisional patent application or may be additionally included into the present patent application as a result of later amendment to the claims.

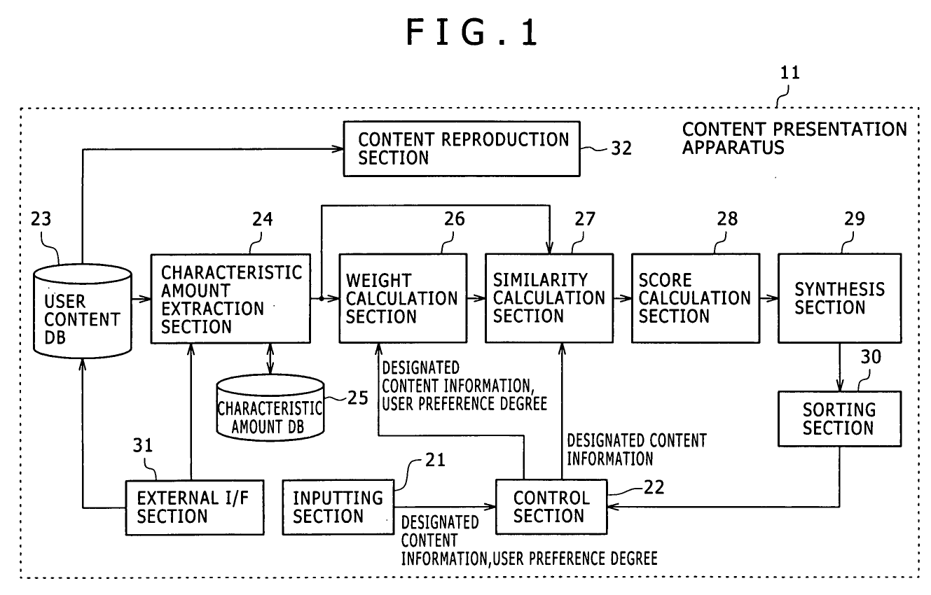

According to an embodiment of the present invention, there is provided an information processing apparatus (for example, a content presentation apparatus 11 of FIG. 1) performing a process for a plurality of object contents that each has a characteristic represented by a plurality of different characteristic amounts and becomes an object of search or recommendation, including weight calculation means (for example, a weight calculation section 26 of FIG. 1) for calculating, from preference degrees of a user with regard to a plurality of designated contents designated from among the object contents and values of the characteristic amounts of the predetermined number of designated contents, weights for the characteristic amounts of the contents to the user, and similarity calculation means (for example, a similarity calculation section 27 of FIG. 1) for calculating a similarity between arbitrary ones of the object contents using the weights for the characteristic amounts to the user calculated by the weight calculation means.

According to an embodiment of the present invention, the information processing apparatus further includes synthetic score calculation means (for example, a synthesis section 29 of FIG. 1) for calculating a synthetic score of each of the arbitrary ones of the object contents using the similarity between the arbitrary ones of the object contents calculated by the similarity calculation means, and presentation means (for example, a control section 22 of FIG. 1) for presenting one of the object contents whose synthetic score is comparatively high as a content which conforms to the preference of the user.

According to an embodiment of the present invention, the information processing apparatus further includes inputting means (for example, an inputting section 21 of FIG. 1) for inputting designated content information representative of the designated contents and preference degrees of the designated contents to the user, the weight calculation means using the designated contents represented by the designated content information inputted by the inputting means and the preference degrees to the user to calculate the weights for the characteristic amounts of the contents to the user from the preference degrees with regard to the predetermined number of designated contents to the user and the values of the characteristic amounts of the predetermined number of designated contents.

According to an embodiment of the present invention, the information processing apparatus further includes extraction means (for example, a characteristic amount extraction section 24 of FIG. 1) for extracting the characteristic amounts of the designated contents.

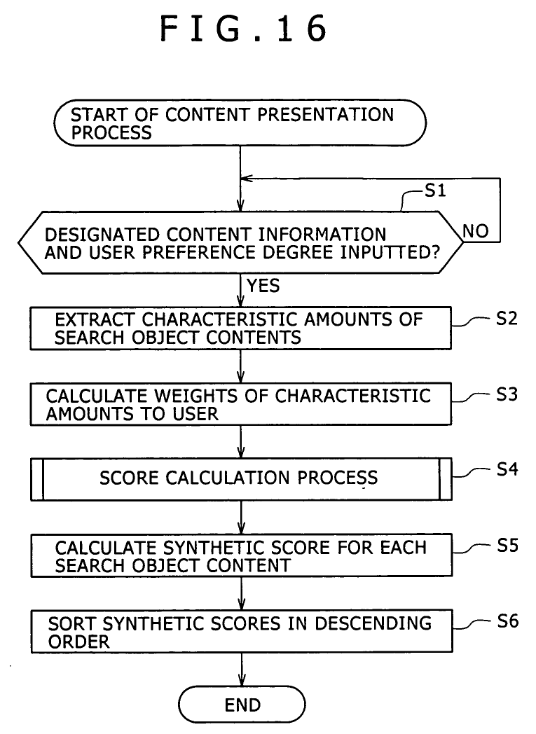

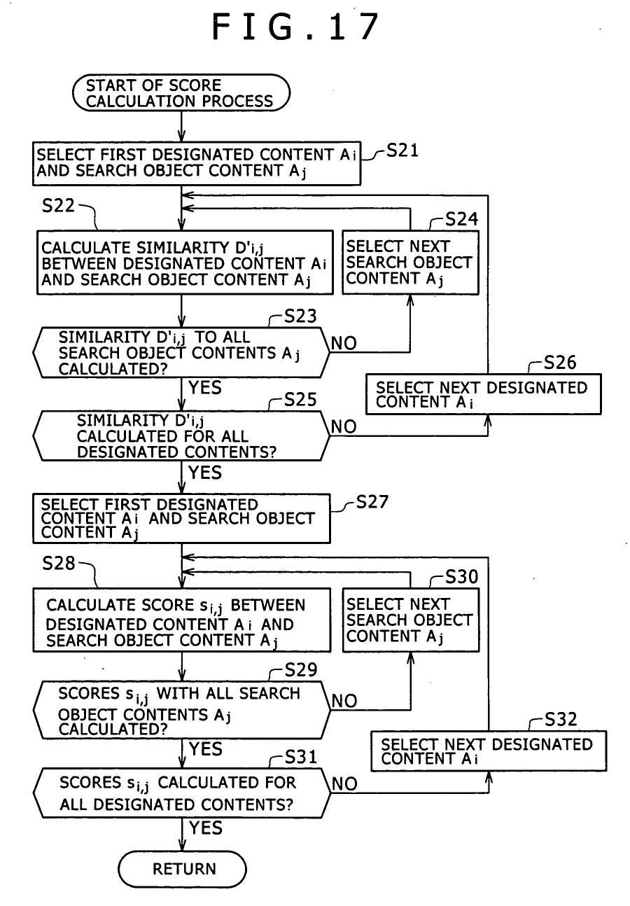

According to an embodiment of the present invention, there is provided an information processing method of performing a process for a plurality of object contents that each has a characteristic represented by a plurality of different characteristic amounts and becomes an object of search or recommendation. The method includes the steps of calculating (for example, a process at step S3 of FIG. 16) from preference degrees of a user with regard to a plurality of designated contents designated from among the object contents and values of the characteristic amounts of the predetermined number of designated contents, weights for the characteristic amounts of the contents to the user, and calculating (for example, a process at step S22 of FIG. 17) a similarity between arbitrary ones of the object contents using the weights for the characteristic amounts to the user calculated by the process at the weight calculation step.

Also particular examples of the program recording on the recording program and the steps of the program are similar to those of the information processing method.

In the following, a content presentation apparatus to which the present invention is applied is described with reference to the drawings.

FIG. 1 shows an example of a configuration of the content presentation apparatus according to an embodiment of the present embodiment.

Referring to FIG. 1, the content presentation apparatus 11 shown searches for contents optimum to a user (conforming to the preference of the user) based on contents (designated contents) designed by the user and presents the searched out contents.

Here, a content that is an object of a search is referred to as search object content (object content). Further, the term “content” is used herein to represent, for example, a broadcasting program of television broadcasting or radio broadcasting, a movie, an image of a photograph or the like, a tune (sound), or information of any of various categories such as the cooking, travel, shopping and so forth presented on a site of the Internet or the like. However, in the following description of the content presentation apparatus 11 of the present embodiment, it is assumed that a content is a tune and a tune conforming to the preference of a user is presented.

An inputting section 21 of the content presentation apparatus 11 is operated by a user to designate, from among contents (tunes) (search object contents) stored in a user content database (DB) 23, a plurality of (a predetermined number of) tunes which have been listened by the user and input the degree of preference to the user with regard to each of the designated contents.

The inputting section 21 supplies designated content information representative of designated contents designated by the user and the degree of preference to the user (hereinafter referred to as user preference degree) with regard to each of the designated contents to a control section 22.

The method of designating a content (designated content) and the method of inputting the preference degree with regard to the designated content (U/I (User Interface)) through the inputting section 21 are not restricted particularly, and any method may be applied. For example, it is possible to display a list of the tunes stored in the user content database 23 on a display section such as an LCD (Liquid Crystal Display) section not shown such that the user designates contents from within the displayed list of tunes by means of a keyboard, a mouse, or the like not shown, whereafter the user inputs a numerical value representative of the preference degree with regard to each of the designated contents.

The control section 22 supplies the designated content information and user preference degrees supplied thereto from the inputting section 21 to a weight calculation section 26. Further, the control section 22 supplies the designated content information to a similarity calculation section 27.

On the other hand, a list of the search object contents sorted in the descending order of the synthesized scores S hereinafter described of the search object contents is supplied from the sorting section 30 to the control section 22. The control section 22 controls the display section to display the list of the search object contents supplied thereto thereby to present the list. It is to be noted that it is possible for the control section 22 to control the user content database 23 to supply a search object content having the highest synthesized score S to a content reproduction section 32 so that the search object content is reproduced by the content reproduction section 32.

The user content database 23 stores therein search object contents, which are an object of a search for contents conforming to the preference of the user. Further, since the user operates the inputting section 21 to input a designated content from among the search object contents stored in the user content database 23, the search object contents include also the designated content. The contents stored in the user content database 23 are, for example, downloaded from an external server (not shown) such as a music distribution (Electronic Music Distribution: EMD) server through an external interface (I/F) section 31.

Further, the contents stored in the user content database 23 are supplied to a characteristic amount extraction section 24 or the content reproduction section 32 as occasion demands. It is to be noted that it is possible to store also contents acquired through a drive or the like not shown from a predetermined recording medium (removable medium) such as, for example, a DVD (Digital Versatile Disc) or a semiconductor memory in addition to contents acquired from the external server through the external I/F section 31.

The characteristic amount extraction section 24 extracts characteristic amounts of all contents (all search object contents including designated contents) stored in the user content database 23 and supplies the extracted values of the characteristic amounts to the weight calculation section 26 and the similarity calculation section 27. It is to be noted that those contents from which a characteristic amount has been extracted once from among the contents stored in the user content database 23 are stored in a characteristic amount database (DB) 25 such that the characteristic amount extraction section 24 can extract the characteristic amounts of the contents from within the characteristic amount database 25 and supplies characteristic amounts of the contents to the weight calculation section 26 and the similarity calculation section 27.

In the present embodiment, since a content is a tune, for example, the tempo, mood, and quantity of sounds are adopted as content characteristic amounts. Further, each content characteristic amount assumes a value within the range from 0 to 1, and the degree of the characteristic is represented by the value. For example, as regards (the characteristic amount of) the tempo, whether the tempo of the tune is high or low is represented by a value within the range from 0 to 1. Meanwhile, as regards (the characteristic amount of) the mood, whether the mood of the tune is dark or light is represented by a value within the range from 0 to 1. Furthermore, as regards (the characteristic amount of) the quantity of sounds, whether the tune is played using a single musical instrument or a great number of musical instruments is represented by a value within the range from 0 to 1.

It is to be noted that, the number of types of characteristic amounts of a content are not limited to such three as described above, and may be two or less or four or more. As the other types of characteristic amounts of tunes, for example, the melody or the chord progression can be adopted.

Also, the characteristic amount extraction section 24 can extract characteristic amounts of a content supplied thereto from the external server through the external I/F section 31 and store the characteristic amounts into the characteristic amount database 25.

Further, the characteristic amount extraction section 24 may make use of a period of time within which the content presentation apparatus 11 is not operated by the user (within a period of time within which the content presentation apparatus 11 is in a standby state) to extract the characteristic amounts of those contents stored in the user content database 23 but from which the characteristic amounts are not extracted and store the extracted characteristic amounts into the characteristic amount database 25.

The characteristic amount database 25 stores the characteristic amounts of contents supplied from the characteristic amount extraction section 24 and supplies the stored characteristic amounts to the characteristic amount extraction section 24.

The weight calculation section 26 receives the designated content information and user preference degrees from the control section 22. Further, the weight calculation section 26 receives the values of all characteristic amounts (of the tempo, mood, and quantity of sounds) of all of the contents stored in the user content database 23 from the characteristic amount extraction section 24.

The weight calculation section 26 calculates, from the values of the preference degrees of the user with regard to a predetermined number of designated contents and the characteristic amounts of the designated contents, a weight for each characteristic amount of each of the contents to the user (weighting coefficient for each characteristic amount) and supplies such calculated weights to the similarity calculation section 27. It is to be noted that a method of determination of a weighting coefficient for each characteristic amount of a content is hereinafter described.

The similarity calculation section 27 receives the values of the characteristic amounts (of the tempo, mood, and quantity of sounds) of all contents stored in the user content database 23 from the characteristic amount extraction section 24 as described above. Further, the similarity calculation section 27 receives the weights for the characteristic amounts of the contents to the user (weighting coefficients of the characteristic amounts) from the weight calculation section 26. Further, the similarity calculation section 27 receives designated content information from the control section 22.

The similarity calculation section 27 weights the values of the characteristic amounts of the contents supplied thereto from the characteristic amount extraction section 24 with the weights to the user supplied thereto from the weight calculation section 26 and uses the weighted characteristic amounts of the contents to calculate the similarity between each of the designated contents and each of the search object contents. Then, the similarity calculation section 27 supplies the thus calculated similarities for all designated contents to a score calculation section 28.

Here, an index representative of the similarity between a designated content and a search object content may be, for example, a Euclidean distance between a vector of the designated content and a vector of the search object content in a three-dimensional space whose axes are represented by the tempo, mood, and quantity of sounds.

In particular, the distance D (similarity) between a designated content and a search object content can be represented by
D=sqrt{(search object content.tempo−designated content.temp) ²+(search object content.mood−designated content.mood)²+(search object content.sound quantity−designated content.sound quantity)²} (1)

Since each of the characteristic amounts of a content in the expression (1) is multiplied by a weight coefficient supplied from the weight calculation section 26, the final similarity D′ between the designated content and the search object content can be represented by the following expression (2):
D′=sqrt{((search object content.tempo−designated content.tempo)×weight coefficient for tempo)²+((search object content.mood−designated content.mood)×weight coefficient for mood)²+((search object content.sound quantity−designated content.sound quantity)×weight coefficient for sound quantity) ²} (2)

It is to be noted that, in the expression (1) and the expression (2), the search object content.tempo represents (the value of) the characteristic amount of the tempo of the search object content, and the search object content.mood represents (the value of) the mood of the search object content while the search object content.sound quantity represents (the value of) the quantity of sounds of the search object content. This similarly applies to the designated content. Further, “sqrt” represents the square root (√).

The index representative of the degree of similarity between a designated content and a search object content is not limited to such a Euclidean distance as described hereinabove, but also it is possible to adopt, for example, the inner product of vectors of the designated content and the search object content.

Here, the total number of designated contents is represented by “n” and the total number of search object contents is represented by “m”. The “n” and “m” are each an arbitrary integer equal to or greater than 2. Since m similarities D′ are calculated with regard to one designated contents, totaling n×m similarities D′ are supplied to the score calculation section 28.

The score calculation section 28 uses the similarities D′ between the designated contents and the search object contents supplied thereto from the similarity calculation section 27 to calculate scores “s” of the designated contents and the search object contents and supplies the calculated scores “s” to a synthesis section 29. Accordingly, also the score calculation section 28 calculate totaling n×m scores “s” similarly to the similarity calculation section 27 and supplies them to the synthesis section 29.

The score calculation section 28 calculates a score “s” such that the score “s ” has a higher value as a designated content and a search object content exhibit a higher similarity D′. Accordingly, where the expression (2) given hereinabove is used for the similarity D′, as the value of the similarity D′ decreases, the similarity increases. Therefore, for the calculation of the score “s”, for example, the following expression (3) can be adopted:
s=1÷(D′+α) (3)
where a represents a predetermined constant used to prevent the dominator from becoming zero even when the similarity D′ is zero (when the designated content and the search object content coincide fully with each other).

On the other hand, where an index exhibiting a higher similarity as it has a higher value is used for the similarity D′, the value of the similarity D′ can be used as it is as the score “s”. In this instance, the score calculation section 28 can be omitted.

The synthesis section 29 calculates, for each search object content, the synthesized score “S” of the search object content by synthesizing the scores “s” of the designated content and the search object content. In particular, the synthesis section 29 adds, for each search object content, the scores s of the designated content and the search object content to calculate the synthesized score “S” of the search object content. Accordingly, as the synthesized score “S” has a higher value, it represents that the content is more optimum to the user (similar to the preference of the user). The synthesis section 29 performs addition of “n” scores “s” for each search object content and supplies “m” synthesized scores “S” (synthesized scores “S” of each search object content) to a sorting section 30.

The sorting section 30 sorts the “m” synthesized scores “S” (synthesized scores “S” of the search object contents) supplied thereto from the synthesis section 29 in the descending order. Then, the sorting section 30 supplies a list of the search object contents sorted in the descending order of the synthesized scores S (in the descending order of the preference to the user) to the control section 22.

The external I/F section 31 is formed from, for example, an ADSL (Asymmetric Digital Subscriber Line) modem, a LAN (Local Area Network) card, or the like and functions as a communication interface with various networks such as the Internet. The external I/F section 31 downloads a content from the external server through a network not shown and supplies the content to the user content database 23 or the characteristic amount extraction section 24 under the control of the control section 22.

The content reproduction section 32 reproduces a content supplied thereto from the user content database 23 under the control of the control section 22. The reproduced tune is outputted from a speaker or the like not shown.

On the content presentation apparatus 11 of FIG. 1 having such a configuration as described above, the inputting section 21 is operated by the user to designate a content and input the preference degree with regard to the designated content.

The characteristic amount extraction section 24 extracts (the value of) the characteristic amount of all contents (designated content and search object contents) stored in the user content database 23 and supplies the values of the extracted characteristic amounts to the weight calculation section 26 and the similarity calculation section 27. The weight calculation section 26 calculates, from the preference degree of the designated content to the user and the values of the characteristic amounts of the designated content, the weights for the characteristic amounts of the contents to the user (weighting coefficients of the characteristic amounts) and supplies the weights to the similarity calculation section 27. The similarity calculation section 27 adds the weights for the characteristic amounts of the contents supplied from the weight calculation section 26 to calculate the similarity D′ between the designated content and the search object contents.

Further, the score calculation section 28 converts the similarities D′ between the designated content and the search object contents into scores “s”, and the synthesis section 29 adds the score “s” (calculates a synthetic score “S”) for each search object content. Then, a list of the search object contents arranged in the descending order of the synthetic scores “S” is supplied from the sorting section 30 to the control section 22 and presented to the user.

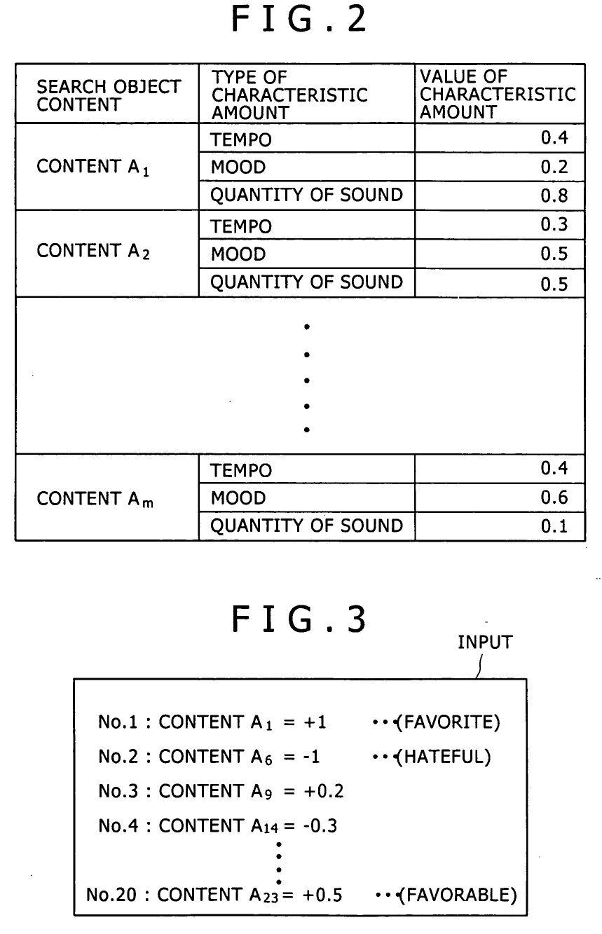

FIG. 2 illustrates an example of data of the characteristic amounts extracted from all search object contents stored in the user content database 23.

The user content database 23 has “m” search object contents stored therein including contents A₁ to Aₘ, and the characteristic amount extraction section 24 extracts the characteristic amounts of the tempo, mood, and sound quantity as seen in FIG. 2 and supplies the characteristic amounts to the weight calculation section 26 and the similarity calculation section 27.

In particular, the values of the characteristic amounts extracted by the characteristic amount extraction section 24 are such as illustrated in FIG. 2. More particularly, the tempo of the content A₁ is 0.4; the mood of the content A₁ is 0.2; and the sound quantity of the content A₁ is 0.8. Meanwhile, the tempo of the content A₂ is 0.3; the mood of the content A₂ is 0.5; and the sound quantity of the content A₂ is 0.5. Further, the tempo of the content Aₘ is 0.4; the mood of the content Aₘ is 0.6; and the sound quantity of the content Aₘ is 0.1. It is to be noted that the values of the characteristic amounts of the contents A₃ to Aₘ₋₁ are omitted in FIG. 2.

It is assumed here that the user operates the inputting section 21 to select, from among all of the search object contents A₁ to Aₘ stored in the user content database 23, totaling 20 contents (designated contents) of the contents A₁, A₆, A₉, A₁₄, . . . , A₂₃ and input the preference degree with regard to each of the designated contents to the user. Here, the preference degree with regard to a designated content to the user is inputted as a value ranging from 1 to −1 such that it is represented by 1 where the designated content is favorite to the user, but by −1 where the designated content is hateful to the user.

In particular, it is inputted through the inputting section 21 that the preference degree with regard the content A₁ to the user is +1 representing that the content A₁ is favorite to the user; the preference degree with regard to the content A₆ is −1 representing that the content A₆ is hateful to the user; the preference degree with regard the content A₉ is +0.2; the preference degree with regard to the content A₁₄ is −0.3; . . . ; and the preference degree with regard to the content A₂₃ is +0.5 representing that the content A₂₃ is favorable to the user. It is to be noted that, in FIG. 3, the representations of No. 1 to No. 20 on the left side of the designated contents represent the inputted number of designated contents. Accordingly, in the present embodiment, the total number of designated contents is 20 (n=20), and the total number of search object contents is equal to or greater than 23 (m≧23).

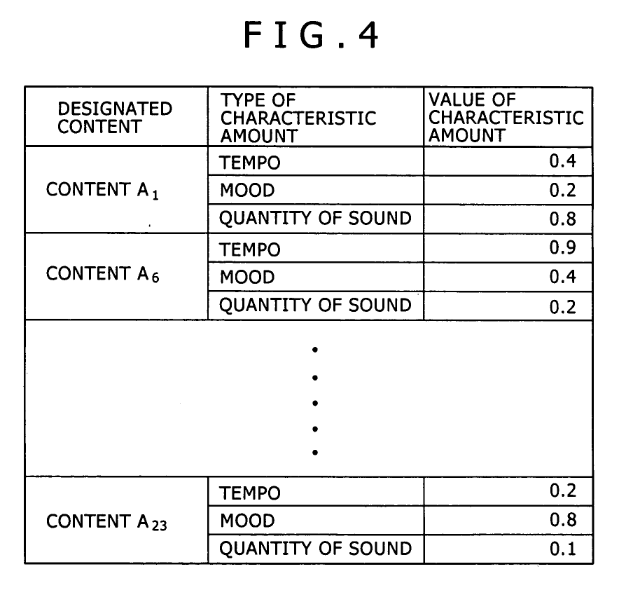

FIG. 4 illustrates an example of data of the characteristic amounts regarding the designated contents inputted in FIG. 3 from among all contents A₁ to Aₘ shown in FIG. 2.

In particular, the tempo of the content A₁ is 0.4; the mood of the content A₁ is 0.2; and the sound quantity of the content A₁ is 0.8. Meanwhile, the tempo of the content A₆ is 0.9; the mood of the content A₆ is 0.4; and the sound quantity of the content A₆ is 0.2. Further, the tempo of the content A₂₃ is 0.2; the mood of the content A₂₃ is 0.8; and the sound quantity of the content A₂₃ is 0.1. It is to be noted that the other data of the designated contents are omitted in FIG. 4.

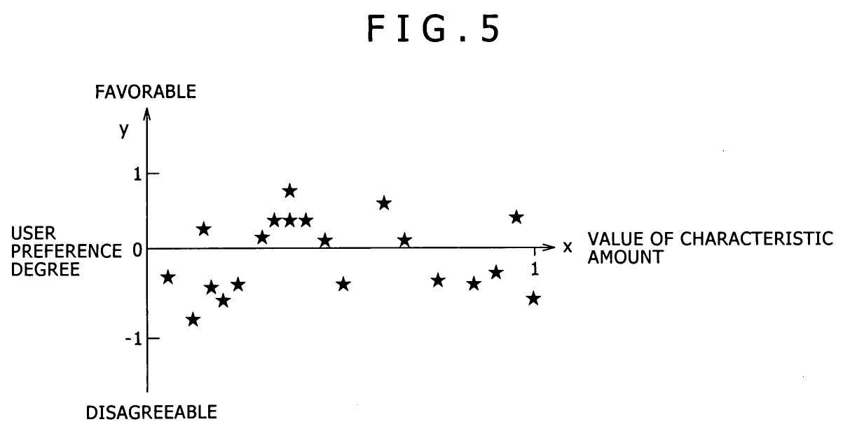

Now, a method of calculating a weight for each characteristic amount of a content to the user (weighting coefficient for each characteristic amount), which is executed by the weight calculation section 26 of the content presentation apparatus 11, is described with reference to FIGS. 5 to 10. It is to be noted that the process described below with reference to FIGS. 5 to 10 is performed for each of (the kinds of) the characteristic amounts.

The weight calculation section 26 calculates a weighting coefficient such that the weighting coefficient for a characteristic amount of a content is set to a low value where the characteristic amount does not have a predetermined correlation (cause-effect relationship) to the user preference degree, but is set to a high value where the characteristic amount has the predetermined correction (cause-effect relationship) to the user preference degree. In other words, the weight calculation section 26 sets a low weighting coefficient for the characteristic amount of a content where the value of the characteristic amount is considered to have no relation to the user preference degree, but sets a high coefficient for the characteristic amount of a content where the value of the characteristic amount apparently has a clear cause-effect relationship to the user preference degree.

As a method of determining a correlation between a first value (value according to a first function) and a second value (value according to a second function), a correlation coefficient or a rank correlation coefficient as a statistic technique is available. However, the correlation coefficient or the rank correlation coefficient is not suitable as a weighting coefficient for a characteristic amount of a content which is used in order that the preference of the user is reflected. Therefore, the weight calculation section 26 calculates a weighting coefficient for a characteristic amount of a content in the following manner.

First, the weight calculation section 26 plots, for one kind of a characteristic amount, 20 data of a designated content on an xy plane whose x axis represents the value of the characteristic amount and whose y axis represents the user preference degree as seen in FIG. 5.

For example, FIG. 5 illustrates an example wherein the value of the characteristic amount of the tempo and the user preference degree of the contents A₁, A₆, . . . , A₂₃ (hereinafter referred to as designated contents A₁ to A₂₃) of FIG. 4.

Star marks in FIG. 5 individually represent the designated contents A₁ to A₂₃. It is to be noted that, since, in the present embodiment, the value of a characteristic amount of a content is represented by a value within the range from 0 to 1 and the user preference degree is represented by a value within the range from 1 to −1, the range of the value that can be taken by the x axis is 0 to 1 and the range of the value that can be taken by the y axis is from 1 to −1.

Then, the x axis having the range from 0 to 1 on the xy plane shown in FIG. 5 is divided into 2^{k}(k is a positive integer) sections, which are represented, in the ascending order of x, as x′=1, 2, 3, . . . , 2^{k}. Here, the number of sections into which the range of the x axis from 0 to 1 is divided may be, for example, 2⁴=16, 2⁷=128, or the like. It is to be noted that, while the dividing number is set to an exponent of 2 for the convenience of calculation, the dividing number may not necessarily be an exponent of 2.

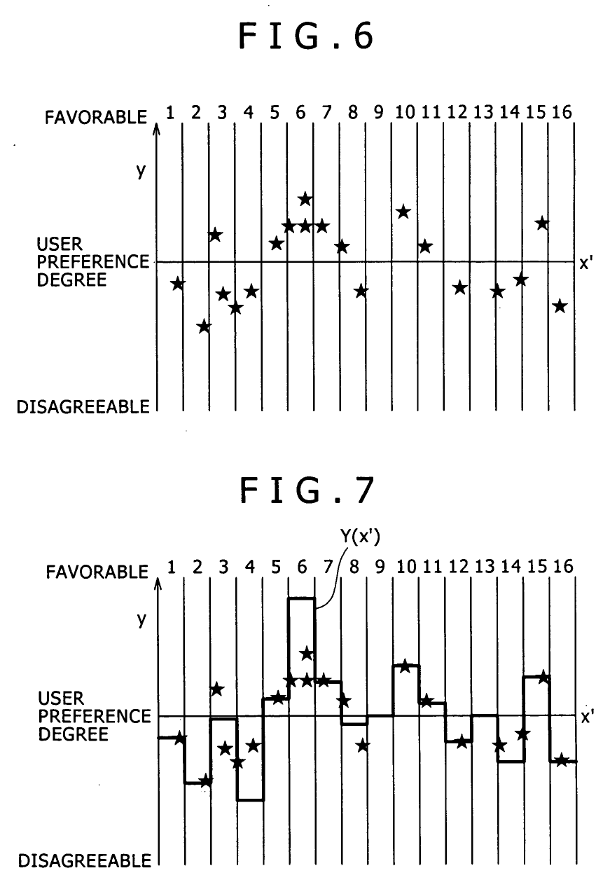

FIG. 6 shows an example wherein the range of the x axis from 0 to 1 is divided into 16 sections.

The weight calculation section 26 calculates the user preference degree Y(x′) for each of the sections x′=1, 2, 3, . . . , 16 shown in FIG. 6. As the user preference degree Y(x′) for each section, a sum value of user preference degrees of designated contents plotted in the section is adopted. In particular, if none of the designated contents A₁ to A₂₃ is plotted in one section, then 0 is set as the user preference degree Y(x′); if one designated content is plotted in one section, then the user preference degree of the plotted designated code is set as the user preference degree Y(x′); and if a plurality of designated contents are plotted in one section, then the sum value of the user preference degrees of the plotted designated contents is set as the user preference degree Y(x′).

FIG. 7 illustrates the user preference degrees Y(x′) calculated for the 16 sections x′ shown in FIG. 6.

In FIG. 7, for example, in the sections x′=1 and 2, one star-mark (a value of a characteristic amount of a designated content) is plotted in one section, and the user preference degree Y(x) overlaps with the value (star-mark) of the characteristic amount of the designated content.

On the other hand, for example, in the section x′=3, two star marks are plotted in the one section, and the positive and negative values of the characteristic amount are summed. Consequently, the user preference degree Y(x) has a value proximate to 0.

Further, for example, where x′=9, since no star mark (value of a characteristic of a designated content) is plotted in one section, the user preference degree Y(x) is 0.

Here, it can be considered that the user preference degree Y(x′) calculated for each section x′ is a discrete function. In the following description, the user preference degree Y(x′) in each section x′ is referred to as discrete function Y(x′).

The weight calculation section 26 uses a low pass filter to apply a filtering process to the discrete function Y(x′).

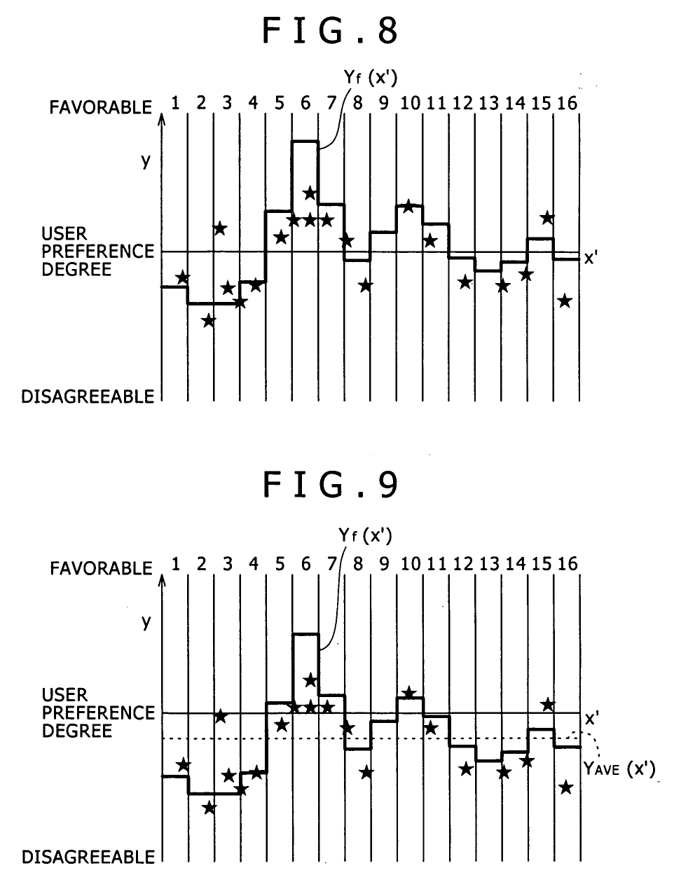

FIG. 8 illustrates a discrete function Y_{f}(x′) after the low pass filtering process is applied to the discrete function Y(x′) shown in FIG. 7.

When the number of contents (sampling number) designated by the user through the inputting section 21 is small, for example, when only one value of a preference degree of a designated content is included in one section, for example, in the case of x′=1 and 2, the discrete function Y(x′) sometimes exhibits an extreme waveform because the discrete function Y(x′) relies much upon the value of the single user preference degree sampled within the section.

Accordingly, a low pass filtering process is applied to the discrete function Y(x′) to remove peculiar sample values so that a smooth curve can be obtained as seen in FIG. 8.

Then, the weight calculation section 26 determines an average value Y_{AVE}(x′) of the discrete function Y_{f}(x′) after the filtering process in all of the sections x′. In the present case, since the number of sections is 16, the average value Y_{AVE}(x′) can be determined by Y_{AVE}(x′)=ΣY_{f}(x′)÷16. It is to be noted that Σ represents the summation regarding the sections x′.

FIG. 9 illustrates an example of the average value Y_{AVE}(x′) calculated with regard to the discrete function Y_{f}(x′) after the filtering process of FIG. 8.

In particular, in FIG. 9, the average value Y_{AVE}(x′) of the discrete function V_{f}(x′) in all sections after the filter processing of FIG. 8 is indicated by a broken line.

The weight calculation section 26 uses the discrete function Y_{f}(x′) and the average value Y_{AVE}(x′) to determine weighting coefficient (weight to the user) Z for the characteristic amount of the content in accordance with the following expression (4):

z=Σabs(Y_{f}(x′)−Y_{AVE}(x′))÷16 (4)

where Σ represents the summation with regard to the sections x′, and abs represents the absolute value.

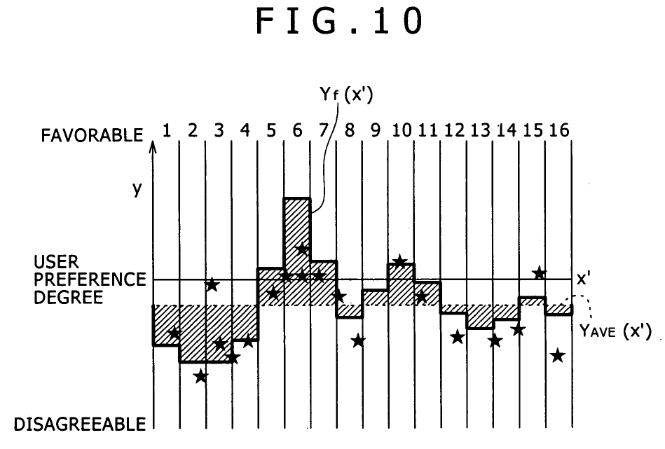

In particular, the weight coefficient Σ determined in accordance with the expression (4) represents an average value in all sections of the area (Σabs(Y_{f}(x′)−Y_{AVE}(x′)) of a portion defined by the discrete function Y_{f}(x′) and the average value Y_{AVE}(x′) and indicated by slanting lines in FIG. 10. Further, the value of the weighting coefficient Z remains within a fixed range irrespective of the number of sections because the area of the slanting ling portion of FIG. 10 represented by Σabs(Y_{f}(x′)−Y_{AVE}(x′) is divided by the number of sections of x′.

The weight calculation section 26 may adopt the following expression (5) in place of the expression (4) to determine the weight coefficient (weight to the user) Z for a characteristic amount of a content.

z=Σ(Y_{f}(x′)−Y_{AVE}(x′))²÷16 (5)

where Σ represents the summation with regard to the sections x′.

The weight calculation section 26 determines a weight coefficient for (the kind of) one characteristic amount in such a manner as described above. Then, the weight calculation section 26 can perform this process for all (of the kinds) of the characteristic amounts to determine the weight coefficients for all of the characteristic amounts.

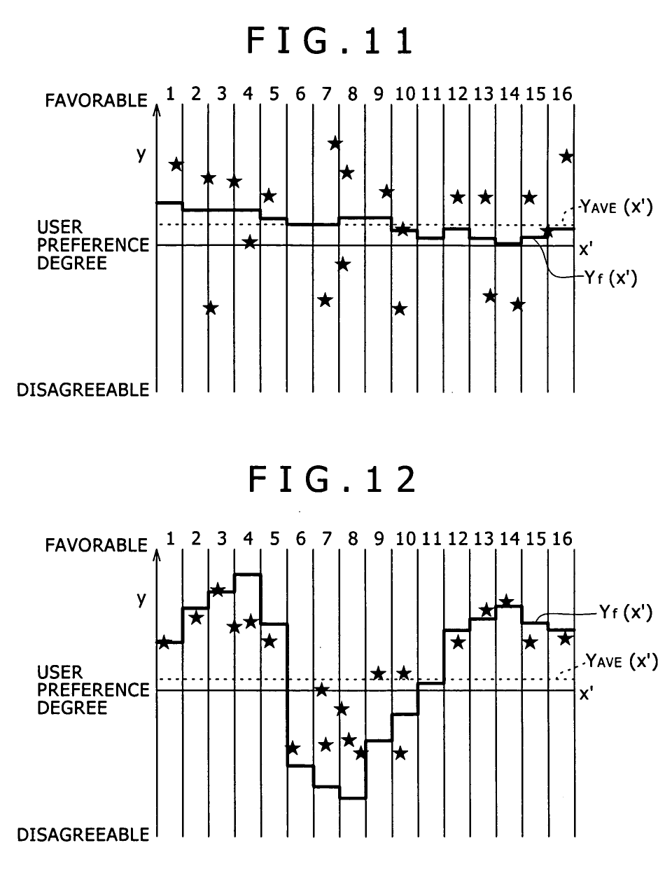

FIGS. 11 to 13 show an example wherein the weight coefficients for all of the characteristic amounts of the tempo, mood, and sound quantity are determined with regard to a certain user (same user).

In particular, FIG. 11 illustrates a distribution of the values of the characteristic amount of the tempo with regard to the designated contents to the user and the user preference degree.

As seen in FIG. 11, those designated contents having a comparatively high user preference degree (are favorable to the user) and those designated contents having a comparative low user preference degree (are hateful to the user) are scattered discretely whatever value the tempo (characteristic amount) has, and the user does not have one-sidedness to the tempo (characteristic amount). Accordingly, the discrete function Y_{f}(x′) extends substantially in parallel to the x′ axis and has a value proximate to the average value Y_{AVE}(x′). Here, the weighting coefficient Z for the tempo to the user, which is determined in accordance with the expression (4) from the preference degrees of the designated contents to the user illustrated in FIG. 11, is for example 0.1.

FIG. 12 illustrates a distribution of the values of the characteristic amount of the mood with regard to the designated contents to the user and the user preference degree.

From FIG. 12, a tendency can be seen clearly that a content having a comparatively low value of the mood (characteristic amount) or another content having a comparatively high value of the mood has a high value of the discrete function Y_{f}(x′) with respect to the average value Y_{AVE}(x′) while a content having a medium value of the mood has a low value of the discrete function Y_{f}(x′) with respect to the average value Y_{AVE}(x′). In other words, a tendency can be seen clearly that the user likes tunes having a dark mood and tunes having a light mood but does not like tunes whose mood is not clear in regard to whether it is light or dark. Here, the weighting coefficient Z for the mood to the user, which is determined in accordance with the expression (4) from the preference degrees of the designated contents to the user illustrated in FIG. 12, is for example 0.3.

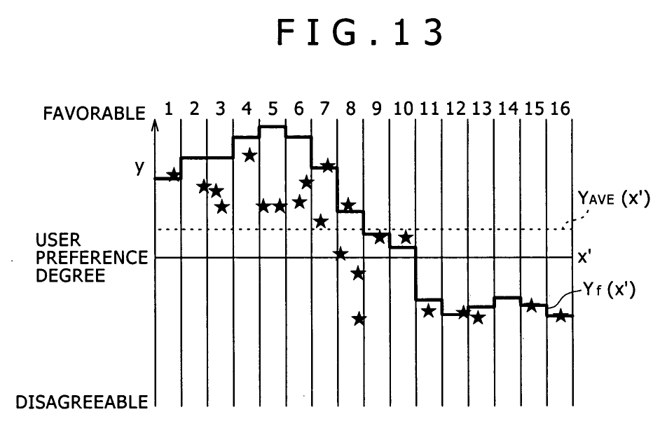

FIG. 13 illustrates a distribution of the values of the characteristic amount of the sound quantity with regard to the designated contents to the user and the user preference degree.

From FIG. 13, a tendency can be seen clearly that a content having a low value of the sound quantity (characteristic amount) has a high value of the discrete function Y_{f}(x′) with respect to the average value Y_{AVE}(x′) while a content having a high value of the sound quantity (characteristic amount) has a low value of the discrete function Y_{f}(x′) with respect to the average value Y_{AVE}(x′). In other words, a tendency can be seen clearly that the user likes tunes having a comparatively small sound quantity but does not like tunes having a comparatively great sound quantity. Here, the weighting coefficient Z for the sound quantity to the user, which is determined in accordance with the expression (4) from the preference degrees of the designated contents to the user illustrated in FIG. 13, is for example 0.3.

Accordingly, according to FIGS. 11 to 13, the weighting coefficient Z for (the characteristic amount of) the tempo is determined as 0.1; the weighting coefficient Z for (the characteristic amount of) the mood is determined as 0.3; and the weighting coefficient Z for (the characteristic amount of) the sound quantity is determined as 0.3.

In particular, of whichever tempo the user listens a tune, the user does not specifically feel favorable or hateful. Accordingly, the user is less sensitive to the tempo (the tempo has little influence on the preference of the user), and therefore, a weight coefficient of 0.1 is given. On the other hand, as regards the mood and the sound quantity, it is clear which mood or which sound quantity the user likes (or hates). Accordingly, since the user is sensitive to the mood and the sound quantity (the mood and the sound quantity are likely to have an influence on the preference of the user), a weight coefficient of 0.3 is given.

In this manner, the weight calculation section 26 can calculate a weight to the user for each characteristic amount of a content so that the weight coefficient for the characteristic amount is high with regard to the mood and the sound quantity to which the user is sensitive while the weight coefficient for the characteristic is low with regard to the tempo to which the user is less sensitive.

Accordingly, only if the user designates, from among search object contents, several contents which have been listened by the user and inputs the preference (preference degree) for each of the designated contents, then the weight calculation section 26 can automatically calculate the weight coefficients for the characteristic amounts of the contents. Consequently, the user can cause the preference for each characteristic amount of the user itself to be reflected on the search of contents without inputting a weight for each characteristic amount of a content.

When a weight coefficient for each characteristic amount is calculated in such a manner as described above and supplied to the similarity calculation section 27, the similarity calculation section 27 calculates, for each of the designated contents, the similarities D′ between the designated content and the search object contents in accordance with the expression (2) given hereinabove.

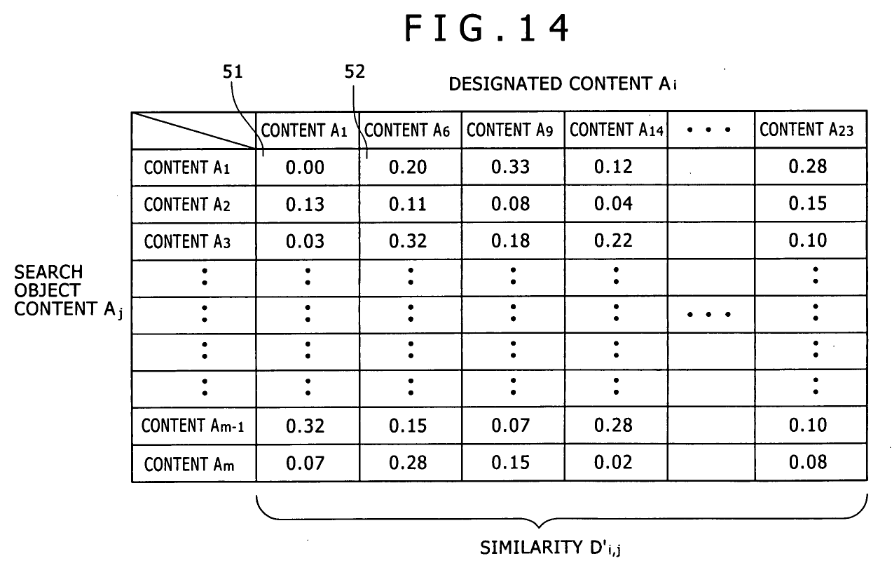

FIG. 14 illustrates an example of results of calculation of the similarity D′ between the designated contents of FIG. 4 and the search object contents of FIG. 2 by the similarity calculation section 27.

A horizontal row of the table shown in FIG. 14 represents all search object contents A₁ to Aₘ(Aⱼ, j=1 to m) stored in the user content database 23, and a vertical column of the table represents designated contents A₁ to A₂₃ (Aⱼ, 1, 6, 9, . . . , 23) designated by the inputting section 21. Further, in a cell at which a row of search object contents and a column of designated contents intersect with each other in the table shown in FIG. 14, the similarity D′_{i,j} between the search object content of the row and the designated content of the column is indicated.

It is to be noted that, since the designated contents are designated from within the user content database 23, also the similarity D′_{i,j} between the same contents is calculated. In this instance, as seen from the cell 51 of FIG. 14, the similarity D′_{1,1} between the same contents (similarity D′_{1,1} between the designated content A₁ and the search object content A₁) is 0. It is apparent also from the expression (2) given hereinabove that the similarity D′_{i,j} between the same contents is 0.

The similarity D′_{6,1} between the designated content A₆ and the search object content A₁ indicated in the cell 52 of FIG. 14 is calculated in the following manner in accordance with the expression (2):
D′_{6,1}=sqrt{((content A₁.tempo−content A₆.tempo)×
weight coefficient for tempo)²+((content A₁.mood−content A₆.mood)×weight coefficient for mood) ²+((content A₁.sound quantity−content A₆.sound quantity)×weight coefficient for sound quantity)²}=sqrt{((0.4×0.9)×0.12+((0.2×0.4)×0.3)2+((0.8×0.2)×0.3)2)=sqrt{0.0385 }≈0.20

Similarly, the similarity D′_{9,1} between the designated content A₉ and the search object content A₁, the similarly degree D′_{14,1} between the designated content A₁₄ and the search object content A₁, . . . , and the similarity D′_{23,1} between the designated content A₂₃ and the search object content A₁ are calculated as 0.33, 0.12, . . . , 0.28, respectively.

Also for the search object contents A₂ to Aₘ, the similarity D′_{i,j} to the designated contents is calculated in a similar manner.

Then, when the similarities D′_{i,j} illustrated in FIG. 14 are supplied from the similarity calculation section 27 to the score calculation section 28, the score calculation section 28 calculates the score s_{i,j} between the designated contents Aᵢ and the search object contents Aⱼ in accordance with the expression (3) based on the similarity D′_{i,j.}

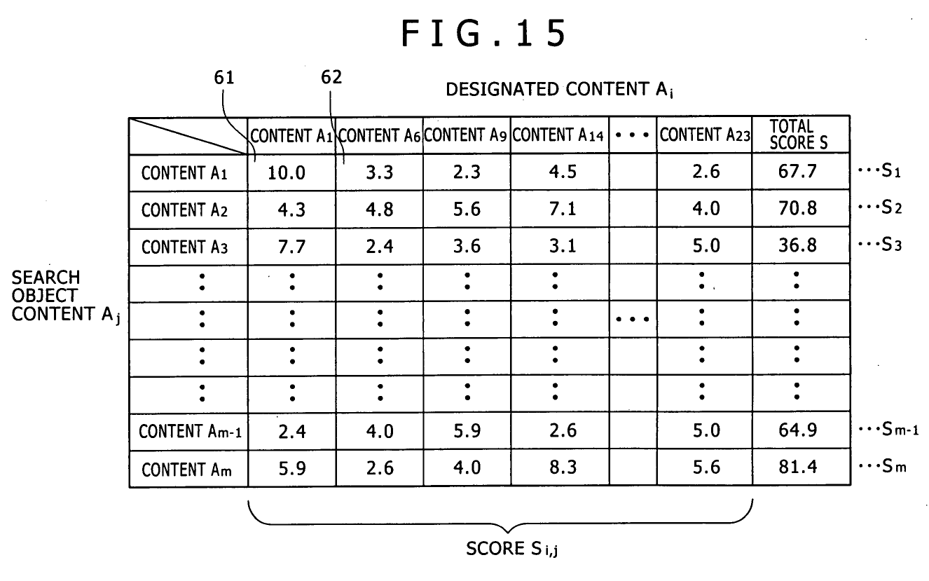

FIG. 15 illustrates an example of calculation of the score s_{i,j} between the designated contents Aᵢ and the search object contents Aⱼ when the similarities D′_{i,j} between the designated contents Aᵢ and the search object contents Aⱼ of FIG. 14 are supplied to the score calculation section 28, and the synthetic scores Sⱼ of the search object contents calculated based on the scores s_{i,j}. It is to be noted that, in the calculation example of FIG. 15, the predetermined constant α in the expression (3) is set to 0.1.

For example, the score S_{1,1} between the designated content A₁ and the search object content A₁ indicated in the cell 61 of FIG. 15 is calculated in the following manner in accordance with the expression (3):
score S_{1,1} between designated content A₁ and search object content A₁=1÷(0.00+0.1)=10.0

Meanwhile, for example, the score S_{6,1} between the designated content A₆ and the search object content A₁ indicated in the cell 62 of FIG. 15 is calculated in the following manner.
score s_{6,1} between designated content A₆ and search object content A₁=1÷(0.20+0.1)≈3.3

Similarly, the scores s_{i,j} between all of the designated contents Aᵢ and all of the search object contents Aⱼ are calculated as seen in FIG. 15 and supplied from the score calculation section 28 to the synthesis section 29.

Then, the synthesis section 29 adds, for each search object content, the scores s_{i,j} between the designated contents Aᵢ and the search object content Aⱼ to calculate a synthetic score Sⱼ of the search object contents Aⱼ.

In FIG. 15, the synthetic scores Sⱼ of the search object contents Aⱼ calculated by the synthesis section 29 are indicated in the rightmost column of the table.

In particular, for example, the synthetic score S₁ of the search object content A₁ (which is also a designated content) is represented by addition of the scores s_{i,j} in the direction of the row as indicated by the following expression and is 67.7.
synthetic score S₁ of content A₁=10.0+3.3+2.3+4.5 . . . +2.6=67.7

Meanwhile, for example, the synthetic score S₂ of the search object content A₂ is represented by addition of the scores s_{i,j} in the direction of the row as indicated by the following expression and is 70.8.
synthetic score S₂ of content A₂=4.3+4.8+5.6+7.1+ . . . +4.0=70.8

Similarly, the synthetic scores S₁ to Sₘ are individually determined with regard to all of the search object contents (contents A₁ to Aₘ) stored in the user content database 23.

Then, the sorting section 30 sorts the synthetic scores S₁ to Sₘ illustrated in FIG. 15 in the descending order of the values and supplies the sorted synthetic scores S₁ to Sₘ to the control section 22. The control section 22 presents a list of the search object contents sorted in the descending order of the synthetic scores S₁ to Sₘ to the user or supplies the search object content having the highest synthetic score from the user content database 23 to the content reproduction section 32 so as to be reproduced by the content reproduction section 32.

Now, the content presentation process of the content presentation apparatus 11 is described with reference to a flow chart of FIG. 16.

First at step S1, the inputting section 21 decides whether or not designated content information and a user preference degree are inputted, that is, whether or not contents are designated and a preference degree of each of the designated content to the user is inputted. The process at step S1 is repeated until after it is decided at step S1 that designated contents and user preference degrees are inputted.

If it is decided at step S1 that designated contents and user preference degrees are inputted, then the processing advances to step S2, at which the control section 22 extracts the characteristic amounts of all of the contents (all search object contents including the designated contents) stored in the user content database 23 and supplies the extracted values of the characteristic amounts of the contents to the weight calculation section 26 and the similarity calculation section 27. Thereafter, the processing advances to step S3.

At step S3, the weight calculation section 26 calculates the weight for the characteristic amounts of the contents to the user (weighting coefficient for the characteristic amounts) from the preference degrees of the designated contents to the user and the values of the characteristic amounts of the designated contents and supplies the calculated weights to the similarity calculation section 27. Thereafter, the processing advances to step S4.

At step S4, the similarity calculation section 27 and the score calculation section 28 perform the score calculation process, whereafter the processing advances to step S5. In the score calculation process at step S4, the similarities D′_{i,j} and the scores s_{i,j} of the designated contents Aᵢ and the search object contents Aⱼ are determined as described hereinabove with reference to FIGS. 14 and 15. It is to be noted that the score calculation process is hereinafter described with reference to FIG. 17.

At step S5, the synthesis section 29 adds, for each of the search object contents, the scores s_{i,j} of the designated contents Aᵢ and the search object content Aⱼ to calculate the synthetic score for each search object content (synthetic score Sⱼ of the search object content Aⱼ) and supplies the calculated synthetic scores to the sorting section 30. Thereafter, the processing advances to step S6.

At step S6, the sorting section 30 sorts the search object contents Aⱼ so that they may be ordered in the descending order of the synthetic scores Sⱼ calculated at step S5 and supplies a list of the search object contents obtained by the sorting to the control section 22. Further, at step S6, the control section 22 presents the list of the search object contents sorted in the descending order of the synthetic scores Sⱼ to the user or supplies the search object content that has the highest synthetic score Sⱼ from within the user content database 23 to the content reproduction section 32 so as to be reproduced by the content reproduction section 32. Thereafter, the processing is ended.

Now, the score calculation process at step S4 of FIG. 16 is described with reference to a flow chart of FIG. 17.

First at step S21, the similarity calculation section 27 selects the first designated content Aᵢ and the first search object content Aⱼ, whereafter, the processing advances to step S22.

At step S22, the similarity calculation section 27 uses the expression (2) to calculate the similarity D′_{i,j} between the designated content Aᵢ and the search object content Aⱼ and supplies a result of the calculation to the score calculation section 28. Thereafter, the processing advances to step S23.

At step S23, the similarity calculation section 27 decides whether or not the similarities D′_{i,j} between the designated content Aᵢ selected at present and all of the search object contents Aⱼ are calculated already. If it is decided that the similarities D′_{i,j} between the designated content Aᵢ and all of the search object contents Aⱼ are not calculated as yet, then the processing advances to step S24, at which the similarity calculation section 27 selects the next search object content Aⱼ, whereafter the processing returns to step S22.

On the other hand, if it is decided at step S23 that the similarities D′_{i,j} to all of the search object contents Aⱼ are calculated with regard to the designated content Aᵢ then the processing advances to step S25.

At step S25, the similarity calculation section 27 decides whether or not the similarity D′_{i,j} is calculated with regard to all of the designated contents.

If it is decided at step S25 that the similarity D′_{i,j} is not calculated with regard to all of the designated contents, then the processing advances to step S26, at which the similarity calculation section 27 selects the next designated content Aᵢ. Thereafter, the processing returns to step S22.

On the other hand, if it is decided at step S25 that the similarity D′_{i,j} is calculated with regard to all of the designated contents, then the processing advances to step S27.

At step S27, the score calculation section 28 selects the first designated content Aᵢ and the first search object content Aⱼ, whereafter the processing advances to step S28.

At step S28, the score calculation section 28 calculates, from the similarity D′_{i,j} between the designated content Aᵢ and the search object content Aⱼ supplied thereto from the similarity calculation section 27, the score s_{i,j} between the designated content Aᵢ and the search object content Aⱼ and supplies the score s_{i,j} to the synthesis section 29. Thereafter, the processing advances to step S29.

At step S29, the score calculation section 28 decides whether or not the score s_{i,j} with all of the search object contents Aⱼ is calculated with regard to the designated content Aᵢ selected at present. If it is decided at step S29 that the score s_{i,j} with all of the search object contents Aⱼ is not calculated with regard to the designated content Aᵢ then the processing advances to step S30, at which the score calculation section 28 selects the next search object content Aⱼ. Thereafter, the processing returns to step S28.

On the other hand, if it is decided at step S29 that the score s_{i,j} with all of the search object contents Aⱼ is calculated with regard to the designated content Aᵢ then the processing advances to step S31.

At step S31, the score calculation section 28 decides whether or not the score s_{i,j} is calculated with regard to all of the designated contents.

If it is decided at step S31 that the score s_{i,j} is not calculated with regard to all of the designated contents, then the processing advances to step S32, at which the score calculation section 28 selects the next designated content Aᵢ. Thereafter, the processing returns to step S28.

On the other hand, if it is decided at step S31 that the score s_{i,j} is calculated with regard to all of the designated contents, then the processing is ended.

As described above, according to the content presentation process of FIG. 16, that one of the search object contents that conforms most to the preference of the user (has the highest score) can be searched out in accordance with the designated contents and the user preference degrees inputted (designated) through the inputting section 21 and presented to the user. In other words, a content optimum to the user can be presented.

Further, in the content presentation process, a weighting coefficient for each characteristic amount of a content is calculated from the designated contents and the user preference degrees inputted through the inputting section 21, and the similarities D′_{i,j} between the designated contents Aᵢ and the search object contents Aⱼ are calculated taking the weighting coefficients for the characteristic amounts into consideration. Then, the synthetic scores Sⱼ of the search object contents Aⱼ are calculated based on the similarities D′_{i,j}. Consequently, the user can search the contents taking a feeling of the user with regard to each characteristic amount for a content (individual difference in the feeling of the user with regard to each characteristic amount) into consideration even if the user does not specifically input a weighting coefficient for each characteristic amount of a content.

It is to be noted that, in the embodiment described above, search object contents are contents owned already by the user, and it can be considered that the contents stored in the user content database 23 are personalized by the content presentation process so that they may conform to the preference of the user.

It is to be noted that the content presentation process can be applied also to another case wherein contents not owned by the user as yet, for example, contents in an external server connected to the external I/F section 31, are searched to find out those contents which conform to the preference of the user so that they may be recommended to the user. Also in this instance, contents can be recommended (searched out) taking a feeling of user with regard to each characteristic amount of contents into consideration.

Further, while, in the embodiment described above, calculation of a similarity and a score is performed for each content, it may otherwise be performed more finely for each characteristic amount of contents such as the tempo or the mood.

Further, while, in the embodiment described hereinabove, designated contents when the weight calculation section 26 calculates the weights for the characteristic amounts to the user and designated contents when the similarity calculation section 27 uses the weights for the characteristic amounts to the user to calculate the similarities D′_{i,j} between the designated contents and the search object contents are same designated contents A₁ to A₂₃, the designated contents where the weights for the characteristic amounts to the user are calculated and the designated contents where the similarities D′_{i,j} are calculated may be different from each other.

Furthermore, while, in the example described hereinabove with reference to FIG. 14, the similarity calculation section 27 calculates the similarity D′_{i,j} with regard to all of the search object contents Aⱼ, it is otherwise possible for the similarity calculation section 27 to calculate the similarity D′_{i,j} only with regard to some of the search object contents Aⱼ and calculate the synthetic score S only from the search object contents with regard to which the similarly degrees D′_{i,j} is calculated. In other words, the similarity calculation section 27 can use the weights for the characteristic amounts to the user calculated by the weight calculation section 26 to calculate the similarity between arbitrary ones of the search object contents.

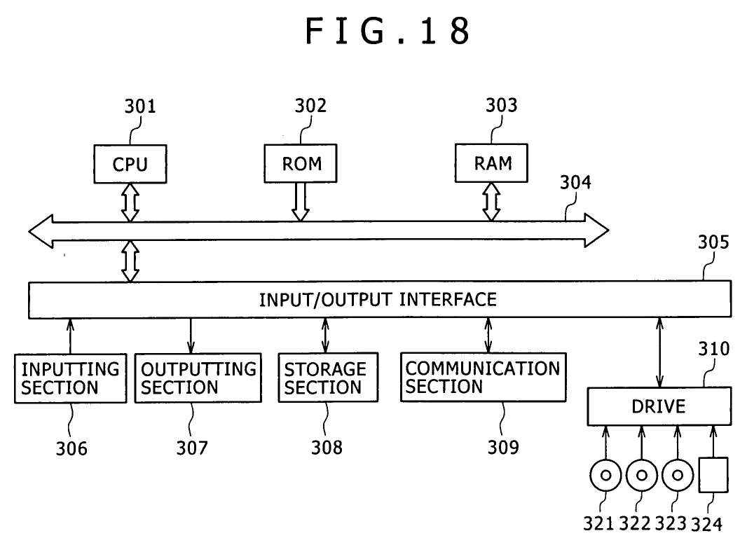

While the series of processes such as the content presentation process described above can be executed by hardware for exclusive use, it may otherwise be executed by software. Where the content presentation process is executed by software, for example, the content presentation process can be implemented by causing the program to be executed, for example, by such a (personal) computer as shown in FIG. 18.

Referring to FIG. 18, a central processing unit (CPU) 301 executes various processes in accordance with a program stored in a ROM (Read Only Memory) 302 or a program loaded from a storage section 308 into a RAM (Random Access Memory) 303. Also data necessary for the CPU 301 to execute the processes are suitably stored into the RAM 303.

The CPU 301 performs the processing of, for example, the control section 22, characteristic amount extraction section 24, weight calculation section 26, similarity calculation section 27, score calculation section 28, synthesis section 29, and sorting section 30 of the content presentation apparatus 11 of FIG. 1.

The CPU 301, ROM 302, and RAM 303 are connected to one another by a bus 304. Also an input/output interface 305 is connected to the bus 304.

An inputting section 306 including a keyboard, a mouse, and so forth, an outputting section 307 including a display unit which may be a CRT (Cathode Ray Tube) or an LCD (Liquid Crystal Display) unit, a speaker, and so forth, a storage section 308 formed from a hard disk or the like, and a communication section 309 including a modem, a terminal adapter, and so forth are connected to the input/output interface 305. The communication section 309 performs a communication process through a network such as the Internet.

The inputting section 306 functions, for example, as the inputting section 21 of the content presentation apparatus 11, and the storage section 308 functions, for example, as the user content database 23 and the characteristic amount database 25 of the content presentation apparatus 11. Further, the communication section 309 functions, for example, as the external I/F section 31 of the content presentation apparatus 11.

Further, as occasion demands, a drive 310 is connected to the input/output interface 305. A magnetic disk 321, an optical disk 322, a magneto-optical disk 323, a semiconductor memory 324, or the like is suitably loaded into the drive 310, and a computer program read from the loaded medium is installed into the storage section 308 as occasion demands.

It is to be noted that, in the present specification, the steps described in the flow charts may be but need not necessarily be processed in a time series in the order as described, and include processes executed in parallel or individually without being processed in a time series.

While a preferred embodiment of the present invention has been described using specific terms, such description is for illustrative purpose only, and it is to be understood that changes and variations may be made without departing from the spirit or scope of the following claims.

What is claimed is:

1. An information processing apparatus performing a process for a plurality of object contents that each has a characteristic represented by a plurality of different characteristic amounts and becomes an object of search or recommendation, comprising:
weight calculation means for calculating, from preference degrees of a user with regard to a plurality of designated contents designated from among the object contents and values of the characteristic amounts of the predetermined number of designated contents, weights for the characteristic amounts of the contents to the user; and
similarity calculation means for calculating a similarity between arbitrary ones of the object contents using the weights for the characteristic amounts to the user calculated by said weight calculation means.

2. The information processing apparatus according to claim 1, further comprising:
synthetic score calculation means for calculating a synthetic score of each of the arbitrary ones of the object contents using the similarity between the arbitrary ones of the object contents calculated by said similarity calculation means; and
presentation means for presenting one of the object contents whose synthetic score is comparatively high as a content conforming to the preference of the user.

3. The information processing apparatus according to claim 1, further comprising inputting means for inputting designated content information representative of the designated contents and preference degrees of the designated contents to the user, said weight calculation means using the designated contents represented by the designated content information inputted by said inputting means and the preference degrees to the user to calculate the weights for the characteristic amounts of the contents to the user from the preference degrees with regard to the predetermined number of designated contents to the user and the values of the characteristic amounts of the predetermined number of designated contents.

4. The information processing apparatus according to claim 1, wherein said weight calculation means calculates the weight for each of the characteristic amounts of the contents to the user such that the weight to the user is set comparatively high for any of the characteristic amounts to which the user is sensitive while the weight to the user is set comparatively low for any of the characteristic amounts to which the user is less sensitive.

5. The information processing apparatus according to claim 1, further comprising extraction means for extracting the characteristic amounts of the designated contents.

6. An information processing method of performing a process for a plurality of object contents that each has a characteristic represented by a plurality of different characteristic amounts and becomes an object of search or recommendation, comprising the steps of:
calculating, from preference degrees of a user with regard to a plurality of designated contents designated from among the object contents and values of the characteristic amounts of the predetermined number of designated contents, weights for the characteristic amounts of the contents to the user; and
calculating a similarity between arbitrary ones of the object contents using the weights for the characteristic amounts to the user calculated by the process at the weight calculation step.

7. A recording medium on which a computer-readable program for performing a process for a plurality of object contents that each has a characteristic represented by a plurality of different characteristic amounts and becomes an object of search or recommendation, the program comprising the steps of:
calculating, from preference degrees of a user with regard to a plurality of designated contents designated from among the object contents and values of the characteristic amounts of the predetermined number of designated contents, weights for the characteristic amounts of the contents to the user; and
calculating a similarity between arbitrary ones of the object contents using the weights for the characteristic amounts to the user calculated by the process at the weight calculation step.

8. A program for causing a computer to execute a process for a plurality of object contents that each has a characteristic represented by a plurality of different characteristic amounts and becomes an object of search or recommendation, the program comprising the steps of:
calculating, from preference degrees of a user with regard to a plurality of designated contents designated from among the object contents and values of the characteristic amounts of the predetermined number of designated contents, weights for the characteristic amounts of the contents to the user; and
calculating a similarity between arbitrary ones of the object contents using the weights for the characteristic amounts to the user calculated by the process at the weight calculation step.

9. An information processing apparatus performing a process for a plurality of object contents that each has a characteristic represented by a plurality of different characteristic amounts and becomes an object of search or recommendation, comprising:
a weight calculation section for calculating, from preference degrees of a user with regard to a plurality of designated contents designated from among the object contents and values of the characteristic amounts of the predetermined number of designated contents, weights for the characteristic amounts of the contents to the user; and
a similarity calculation section for calculating a similarity between arbitrary ones of the object contents using the weights for the characteristic amounts to the user calculated by said weight calculation section.
